(19) United States
(12) Patent Application Publication
(10) Pub. No.: US 2024/0253087 A1
(43) Pub. Date: Aug. 1, 2024

(54) Remote controlled high pressure water washing apparatus for installation on a boom lift device

(71) Applicant: Jonathan Berthiaume, L'Assomption, CA (US)

(72) Inventor: Jonathan Berthiaume, L'Assomption, CA (US)

(21) Appl. No.: 18/101,589

(22) Filed: Jan. 26, 2023

(51) Int. Cl. B08B 3/02; B08B 1/00; B08B 1/04

(52) U.S. Cl. CPC B08B 3/024; B08B 1/12; B08B 1/30; B08B 1/32

(57) ABSTRACT

A remote controlled high pressure water washing apparatus for installation on a boom lift device is provided. It includes a framework having an attachment bracket that releasably attaches to a boom end from a man-lift machine. The framework includes vertical and horizontal rails such that the vertical rails are made to slide along the length of the horizontal rails and nozzle members can slide vertically along the length of the vertical rails. The combination of horizontal and vertical motion of the vertical rails and the nozzle members allow for a variety of adjustments of the nozzles for a variety of applications. The framework can be detached from the attachment bracket and be replaced by a brush holder onto which is rotationally attached a brush. There is a pivoting interface member between the attachment bracket and either the brush holder or the framework which allows them to pivot along two axes.

### CROSS-REFERENCE TO RELATED APPLICATIONS

N/A

### BACKGROUND OF THE INVENTION

### 1. Field of the Invention

The present invention relates generally to a high pressure commercial washing apparatus but more particularly to a remote controlled high pressure water washing apparatus for installation on a boom lift device.

### 2. Description of Related Art

The use of power washers installed on cranes, booms, and similar devices is well known. Besides the use of power washing, sand blasting is also used. These devices are often controlled by cable connections or by wireless connections such that a worker does not need to be located way up at the end of the crane or boom. Due to the various requirements of the numerous types and shapes of objects to be treated, many apparatuses have been developed over the years, and there is still room for improvement in the field.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide for a remote controlled high pressure water washing apparatus for installation on a boom lift device.

In one aspect of the invention, a remote controlled high pressure water washing apparatus for installation on a boom lift device is provided, having a framework comprising a horizontal rail and a pair of vertical rails; a vertical motor assembly configured to enable the horizontal rail to slide along a length of the pair of vertical rails; an attachment bracket connected to the framework; a plurality of nozzles members pivotally attached to the horizontal rail; and, a pivoting connector member having a proximal end and a distal end, wherein the proximal end is configured to pivotally attach to a telescopic boom arm of the boom lift device and the distal end is configured to pivotally attach to the attachment bracket.

In one embodiment, the pivoting connector member includes a Z-axis pivot at the proximal end, wherein the Z-axis pivot is pivotally attached to a Y-axis pivot on the distal end. In another embodiment, the Z-axis pivot and the Y-axis pivot are releasably attached via locking pins.

In yet another aspect of the invention, an apparatus for installation on a boom lift device is provided, comprising a roller brush holder; a roller brush coupled to the roller brush holder; an attachment bracket coupled the roller brush holder; and, a pivoting connector member having a proximal end and a distal end, wherein the proximal end is configured to pivotally attach to a telescopic boom arm of the boom lift device and the distal end is configured to pivotally attach to the attachment bracket. In one embodiment, a roller brush motor assembly for rotating the roller brush is provided.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1A is a top view of the high pressure water washing apparatus according to an embodiment of the present invention.

FIG. 1B is a front view of the high pressure water washing apparatus according to an embodiment of the present invention.

FIG. 2 is an isometric view of the connector member connected to the telescopic boom arm according to an embodiment of the present invention.

FIG. 3A-C are side views of the embodiment of FIGS. 1A-B installed on a crane.

FIG. 4A-C are top views of the embodiment of FIGS. 1A-B installed on a crane., showing lateral pivoting of the framework along a vertical axis.

FIG. 5A-C are front views of the embodiment of FIGS. 1A-B installed on a crane, showing rotation of the framework around a horizontal axis.

FIG. 6A-C are top views of the embodiment of FIGS. 1A-B installed on a crane, showing lateral pivoting of the framework along a horizontal axis.

FIG. 7 is an isometric view of the roller brush and frame according to an embodiment of the present invention.

FIG. 8 is a side view of the roller brush and frame of FIG. 7.

FIGS. 9A-C are front views of the embodiment of FIG. 7 installed on a crane, and showing rotation of the roller brush along a horizontal axis.

FIGS. 10A-C are side views of the embodiment of FIG. 7 installed on a crane, and showing pivoting of the roller brush along a horizontal axis.

FIGS. 11A-C are top views of the embodiment of FIG. 7 installed on a crane, and showing rotation of the roller brush along a vertical axis.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a remote controlled high pressure water washing apparatus for installation on a boom lift device.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

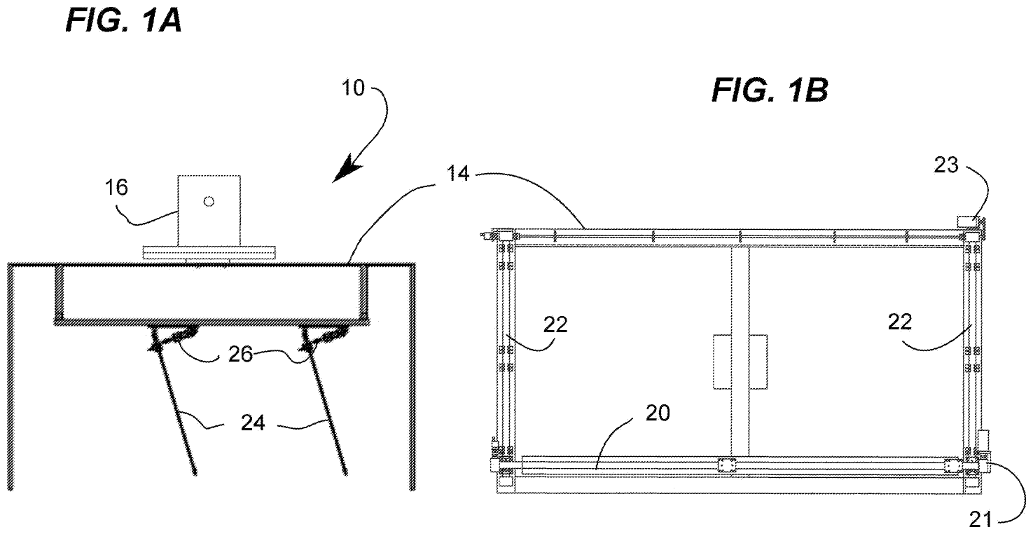

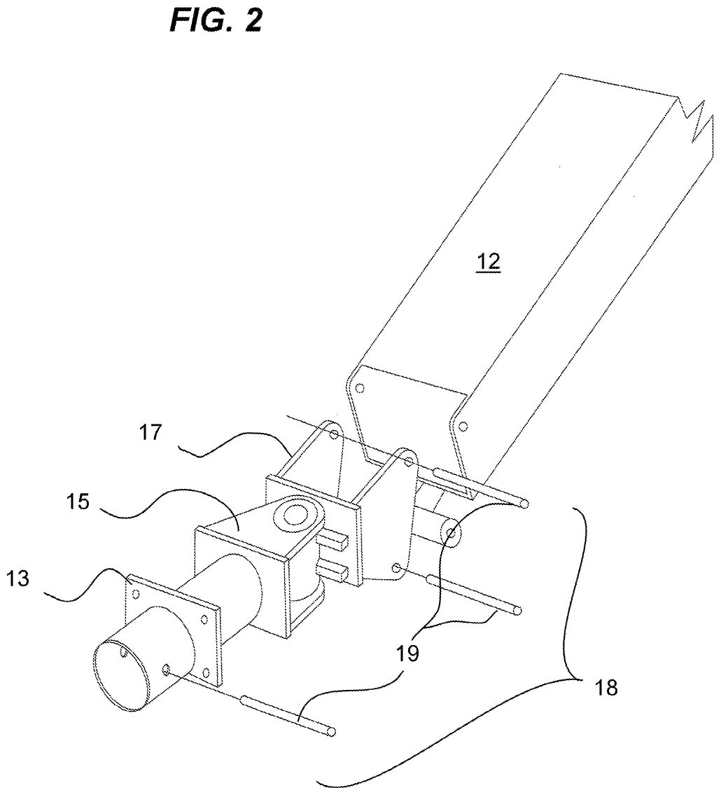

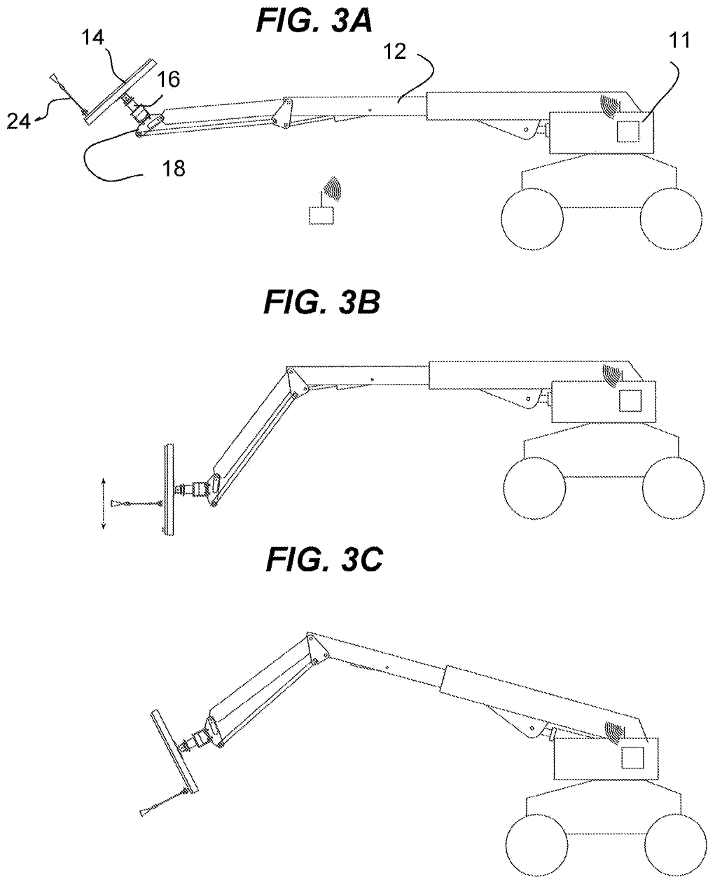

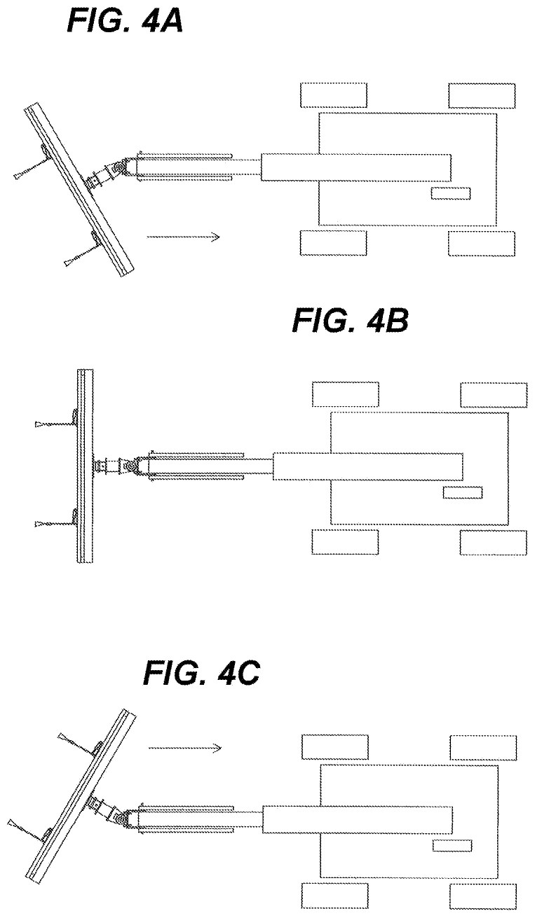

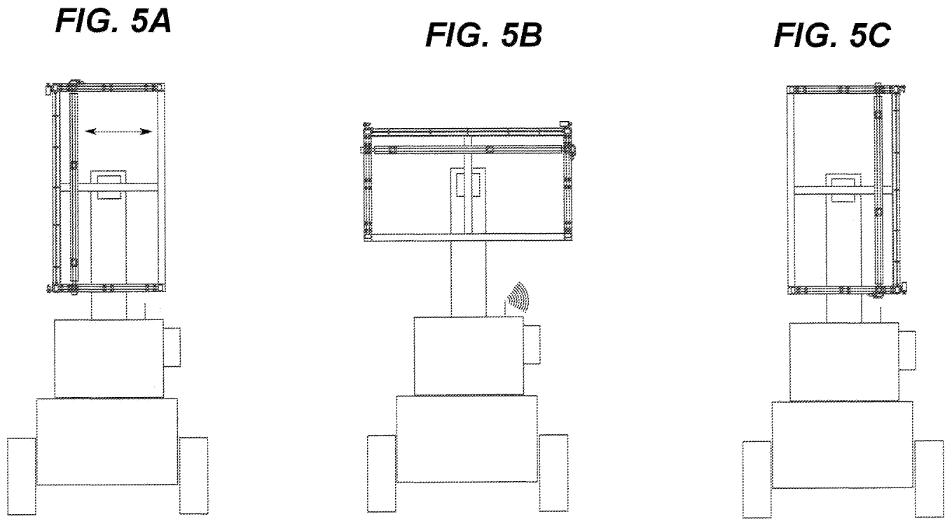

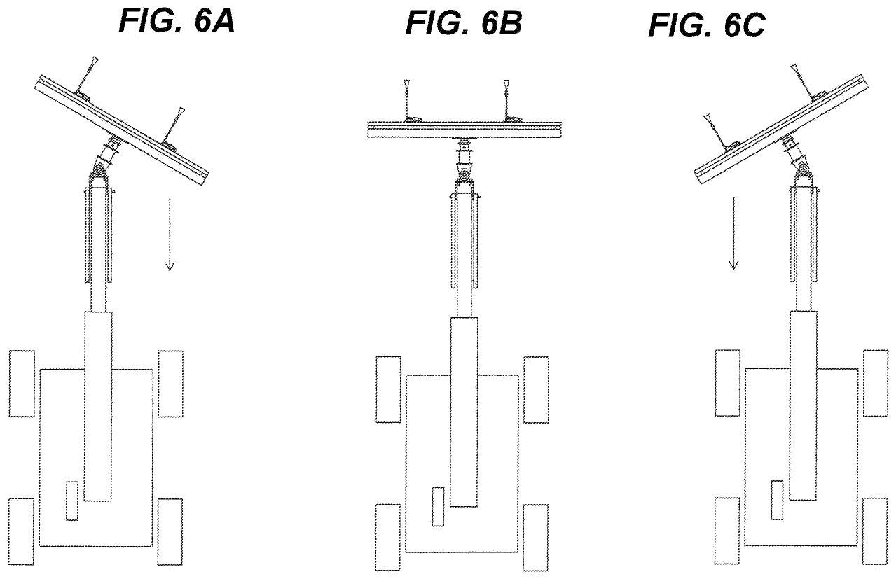

Referring now to any of the accompanying FIGS. 1-6, a remote controlled high pressure water washing apparatus 10 for installation on a telescopic boom arm 12, forming part of a man-lift machine 11 is shown. In one embodiment, the remote controlled high pressure water washing apparatus 10 is comprised of framework 14 having an attachment bracket 16 that releasably attaches to a connector member 18. In some embodiments, the connector member 18 is releasably attached to the telescopic boom arm 12. In some embodiments, the connector member 18 is further comprised of a Z axis pivot 17, which is releasably attached to the boom

arm 12 by way of locking pins 19. Next, the Z axis pivot 17 is pivotally attached a Y axis pivot 15 from which extends to an interface beam 13 to which is releasably attached to the high pressure washing apparatus 10 by way of the locking pins 19. Advantageously, this allows the framework to pivot along two axes enabling great range of mobility.

In some embodiments, the framework 14 is comprised of a horizontal rail 20 and a pair of vertical rails 22 such that the horizontal rail 20 slides along the length of the horizontal rails 20 by way of a vertical motor assembly 21. In one embodiment, at least one but preferably a plurality of nozzles members 24 are pivotally attached to the horizontal rail 20. In some embodiments, the nozzle members 24 have a sweeping movement actuated by way of linear actuators 26, they can also slide horizontally along the length of the horizontal rail 20 by way of a horizontal motor assembly 23. Advantageously, the combination of horizontal and vertical motion of the horizontal and vertical rails 20, 22 and the nozzle members 24 allow for a variety of adjustments of the nozzle members 24 for a variety of applications. In some embodiments, a plurality of rods 28, one for each corner of the framework 14 serves as a guide to keep the nozzles 24 at a distance from the surface being operated on.

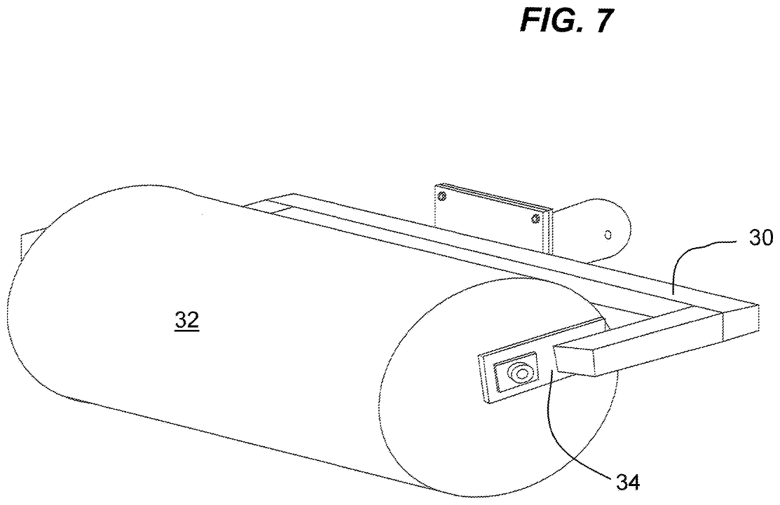

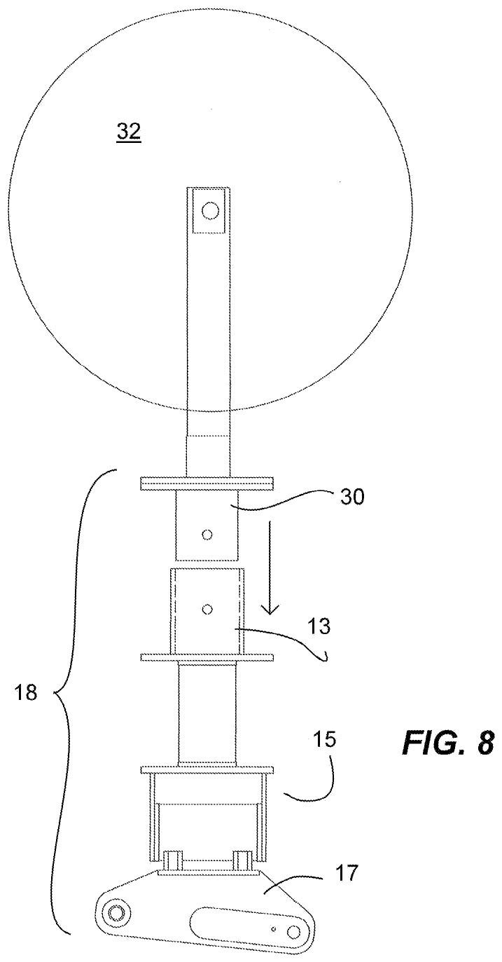

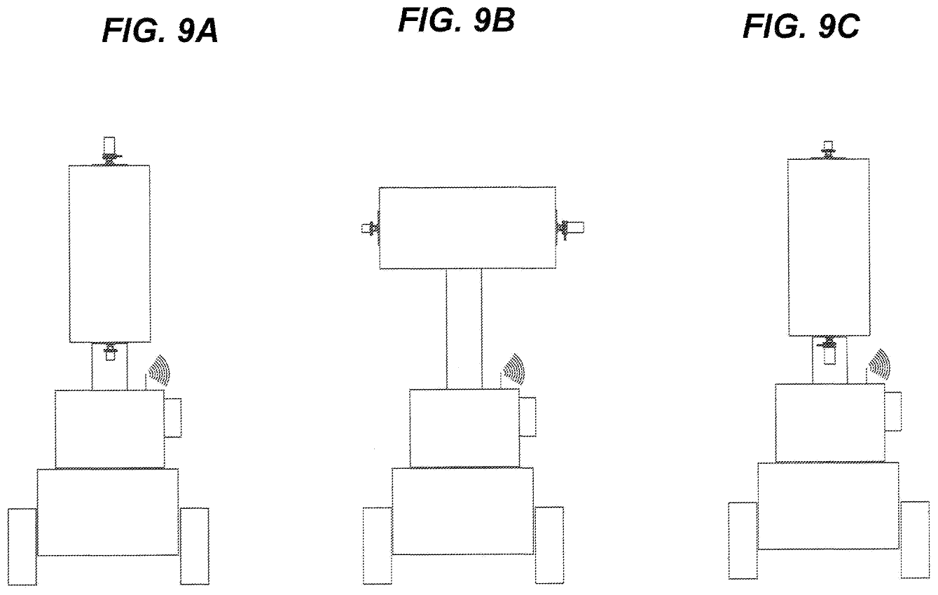

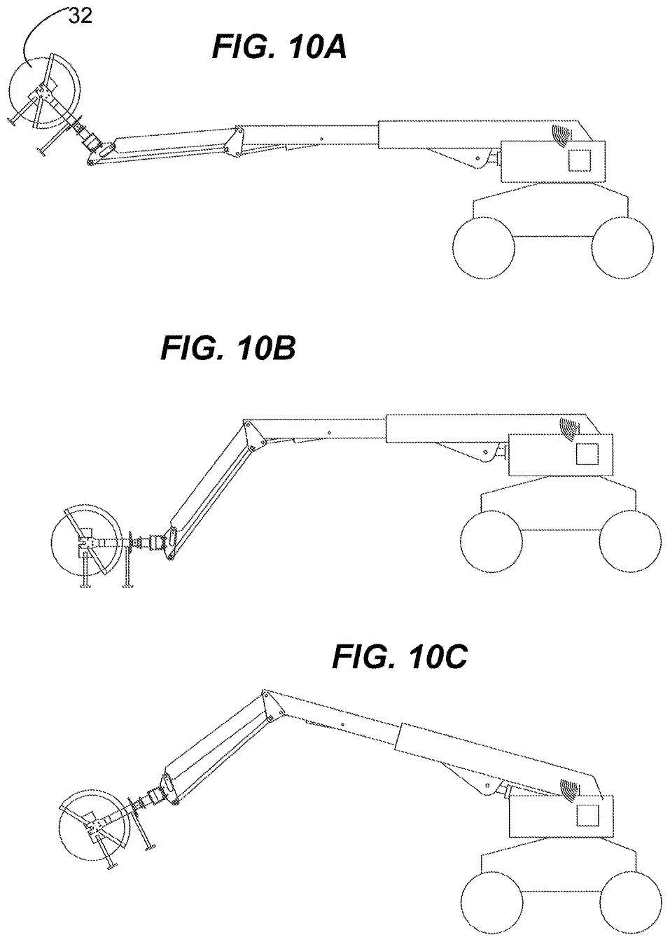

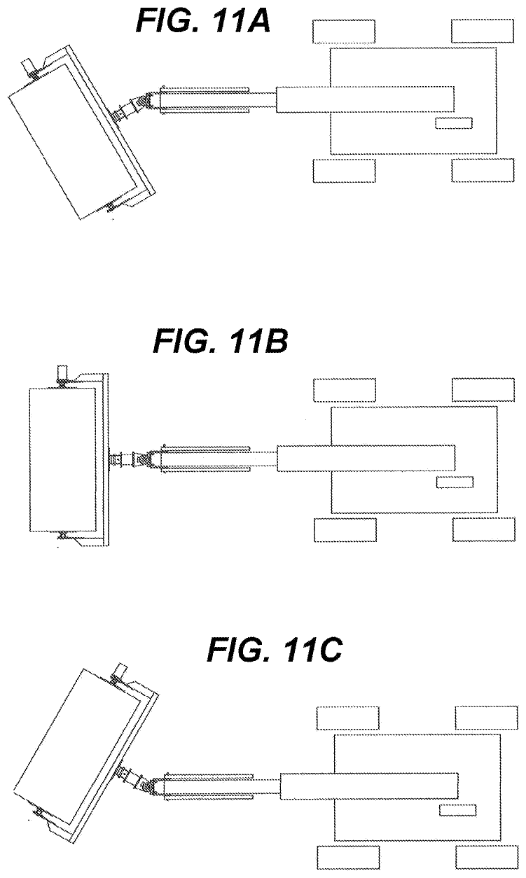

Now referring to FIGS. 7-11, the framework 14 can be detached from the attachment bracket 16 and be replaced by a roller brush holder 30 which is configured to rotationally attach to a roller brush 32. In some embodiments, there is a roller brush motor assembly 34 for rotating the roller brush 32.

Further, there is a pivoting interface connector member 18 between the attachment bracket 16 and either the brush holder 30 or the framework 14 which allows them to pivot along two axes (Z axis pivot 17 and a Y axis pivot 15 as previously discussed). In some embodiments, the high pressure washing apparatus 10 is controlled remotely by way of wireless or cable control in a fashion similar to other types of heavy equipment and as such need not be further discussed herein. When used on a wheeled lift vehicle as shown in the figures, the vehicle itself along with the boom arm, and of course, the washing apparatus itself, all can be controlled by cable connection or wireless connection using controllers as known in the art.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A remote controlled high pressure water washing apparatus for installation on a boom lift device comprising:
framework comprising a horizontal rail and a pair of vertical rails;
a vertical motor assembly configured to enable the horizontal rail slide along a length of the pair of vertical rails;
an attachment bracket connected to the framework;
a plurality of nozzles members pivotally attached to the horizontal rail; and,
a pivoting connector member having a proximal end and a distal end, wherein the proximal end is configured to pivotally attach to a telescopic boom arm of the boom lift device and the distal end is configured to pivotally attach to the attachment bracket.

2. The remote controlled high pressure water washing apparatus of claim 1, wherein the pivoting connector member includes a Z-axis pivot at the proximal end, wherein the Z-axis pivot is pivotally attached to a Y-axis pivot on the distal end.

3. The remote controlled high pressure water washing apparatus of claim 2, wherein the Z-axis pivot and the Y-axis pivot are releasably attached via locking pins.

4. An apparatus for installation on a boom lift device comprising:
a roller brush holder;
a roller brush coupled to the roller brush holder;
an attachment bracket coupled the roller brush holder; and,
a pivoting connector member having a proximal end and a distal end, wherein the proximal end is configured to pivotally attach to a telescopic boom arm of the boom lift device and the distal end is configured to pivotally attach to the attachment bracket.

5. The apparatus of claim 4, further comprising a roller brush motor assembly for rotating the roller brush.

6. The apparatus of claim 4, wherein the pivoting connector member includes a Z-axis pivot at the proximal end, wherein the Z-axis pivot is pivotally attached to a Y-axis pivot on the distal end.

7. The apparatus of claim 6, wherein the Z-axis pivot and the Y-axis pivot are releasably attached via locking pins.
